(19) United States
(12) Patent Application Publication
(10) Pub. No.: US 2023/0389589 A1
(43) Pub. Date: Dec. 7, 2023

(54) Loosening Agent for Starch-Containing Food

(71) Applicant: The Nisshin OilliO Group, Ltd., Tokyo (JP)

(72) Inventors: Taichi Watanabe, Yokohama-shi, Kanagawa (JP); Takahiro Okada, Yokohama-shi, Kanagawa (JP); Michio Kasai, Yokohama-shi, Kanagawa (JP)

(73) Assignee: The Nisshin OilliO Group, Ltd., Tokyo (JP)

(21) Appl. No.: 18/027,612

(22) PCT Filed: Dec. 13, 2021
(86) PCT No.: PCT/JP2021/045818

§ 371 Date: Mar. 21, 2023

(30) Foreign Application Priority Data
Dec. 18, 2020 (JP) 2020-210338

(51) Int. Cl. A23L 29/269; A23L 29/10; A23L 29/244

(52) U.S. Cl. CPC A23L 29/27; A23L 29/244; A23L 29/10

(57) ABSTRACT

Provided is a loosening agent for a starch-containing food having a favorable loosening property. Also provided are a method for improving a loosening property of a starch-containing food, and a method for producing a starch-containing food having a favorable loosening property. Specifically, a loosening agent for a starch-containing food, that is for use as an emulsion product or is for use as an emulsion product by adding water to the loosening agent for a starch-containing food, comprising: an oil and/or fat composition containing an oil and/or fat and an emulsifier; and a thickening polysaccharide, wherein the emulsion product has a viscosity of 50 to 10000 mPa·s (25° C.) is provided.

### TECHNICAL FIELD

The present invention relates to a loosening agent for a starch-containing food, a method for improving a loosening property of a starch-containing food, and a method for producing a starch-containing food.

### BACKGROUND ART

Soba noodles, udon noodles, Chinese noodles, pastas, and the like are boiled to eat, but many which can be eaten as they are without heating or the like at all are also distributed. However, these noodles are likely to involve problems of sticking of pieces of the noodle to each other during distribution or storage, and the like, and it has been conducted to improve the loosening property by coating noodles with an oil and/or fat so as to prevent adhesion of the noodles.

For example, Patent Literature 1 proposes a noodle loosening improver using a lecithin and a diglycerol fatty acid ester as essential components, and comprising an emulsifier such as a polyglycerol fatty acid ester. In addition, Patent Literature 2 proposes an oil and/or fat composition for improving noodle loosening, comprising a lecithin and a polyglycerol fatty acid ester.

These compositions have a certain property of loosening noodles. However, for example, in the case where there is large content of water on the surface of a noodle, there have been cases where those compositions cannot exhibit a sufficient loosening property because their adhesion to noodles becomes poor.

### CITATION LIST

### Patent Literatures

Patent Literature 1: Japanese Unexamined Patent Application Publication No. Hei 10-035024
Patent Literature 2: Japanese Unexamined Patent Application Publication No. Hei 11-221033

### SUMMARY OF INVENTION

An object of the present invention is to provide a loosening agent for a starch-containing food having a favorable loosening property. In addition, a further object of the present invention is to provide a method for improving a loosening property of a starch-containing food, and a method for producing a starch-containing food having a favorable loosening property.

### Means for Solution of the Problems

As a result of conducting earnest studies, the present inventors found that a starch-containing food was provided with a favorable loosening property by using a loosening agent for a starch-containing food, comprising specific components as an emulsion product having a specific viscosity, found that the above-described objects were achieved, and completed the present invention.

Specifically, the present invention provides [1] to described below.
[1] A loosening agent for a starch-containing food, that is for use as an emulsion product or is for use as an emulsion product by adding water to the loosening agent for a starch-containing food, comprising:
   an oil and/or fat composition containing an oil and/or fat and an emulsifier; and
   a thickening polysaccharide, wherein
   the emulsion product has a viscosity of 50 to 10000 mPa·s (25° C.).
[2] The loosening agent for a starch-containing food according to the above [1], wherein
   a content of the oil and/or fat in the oil and/or fat composition is 20 to 99.5% by mass,
   a content of the emulsifier in the oil and/or fat composition is 0.5 to 80% by mass, and
   an HLB of the emulsifier is 2 to 10.
[3] The loosening agent for a starch-containing food according to the above [1] or [2], wherein
   the emulsifier is one or two or more selected from glycerol mono-fatty acid esters, polyglycerol fatty acid esters, polyglycerol polyricinoleates, organic acid monoglycerides, sorbitan fatty acid esters, sucrose fatty acid esters, polysorbates, propylene glycol fatty acid esters, and lecithins.
[4] The loosening agent for a starch-containing food according to any one of the above [1] to [3], wherein
   in the oil and/or fat composition,
   a content of a diglycerol mono-fatty acid ester and/or a triglycerol mono-fatty acid ester is 10 to 60% by mass, and
   a content of one or two or more emulsifiers selected from polyglycerol fatty acid esters in which an average degree of polymerization of polyglycerol is 4 or more, organic acid monoglycerides, propylene glycol fatty acid esters, and lecithins is 0 to 40% by mass.
[5] The loosening agent for a starch-containing food according to any one of the above [1] to [4], wherein
   the thickening polysaccharide is one or two or more selected from xanthan gum and galactomannans.
[6] The loosening agent for a starch-containing food according to any one of the above [1] to [5], wherein
   a mass ratio between the oil and/or fat composition and the thickening polysaccharide in the loosening agent for a starch-containing food is oil and/or fat composition:thickening polysaccharide=300:1 to 3:1, and/or
   a content of the thickening polysaccharide in the emulsion product is 0.01 to 2.5% by mass.
[7] The loosening agent for a starch-containing food according to any one of the above [1] to [6], wherein
   30% by mass or more of a constituent fatty acid of the oil and/or fat in the oil and/or fat composition is a linear saturated fatty acid having 8 to 10 carbon atoms, and
   60% by mass or more of a constituent fatty acid of the emulsifier in the oil and/or fat composition is an unsaturated fatty acid.
[8] The loosening agent for a starch-containing food according to any one of the above [1] to [7], further comprising:
   more than 0% by mass and 99.8% by mass or less of water.
[9] The loosening agent for a starch-containing food according to [8], that is in a form of an emulsion product having a viscosity of 50 to 10000 mPa·s (25° C.).
[10] A starch-containing food having an improved loosening property, comprising:
   a starch-containing food; and
   the loosening agent for a starch-containing food according to any one of the above [1] to [9], that is applied to a surface of the starch-containing food.
[11] A method for improving a loosening property of a starch-containing food, comprising the steps of:
   emulsifying an oil and/or fat composition containing an oil and/or fat and an emulsifier together with a thickening polysaccharide to obtain an emulsion product having a viscosity of 50 to 10000 mPa·s (25° C.); and
   applying the emulsion product to a starch-containing food.
[12] The method for improving a loosening property of a starch-containing food according to the above [11], wherein
   a content of the oil and/or fat in the oil and/or fat composition is 20 to 99.5% by mass,
   a content of the emulsifier in the oil and/or fat composition is 0.5 to 80% by mass, and
   an HLB of the emulsifier is 2 to 10.
[13] The method for improving a loosening property of a starch-containing food according to the above or [12], wherein
   in the oil and/or fat composition,
   a content of a diglycerol mono-fatty acid ester and/or a triglycerol mono-fatty acid ester is 10 to 60% by mass, and
   a content of one or two or more emulsifiers selected from polyglycerol fatty acid esters in which an average degree of polymerization of polyglycerol is 4 or more, organic acid monoglycerides, propylene glycol fatty acid esters, and lecithins is 0 to 40% by mass.
[14] The method for improving a loosening property of a starch-containing food according to any one of the above to [13], wherein
   the thickening polysaccharide is one or two or more selected from xanthan gum and galactomannans,
   a mass ratio between the oil and/or fat composition and the thickening polysaccharide is oil and/or fat composition:thickening polysaccharide=300:1 to 3:1, and/or
   a content of the thickening polysaccharide in the emulsion product is 0.01 to 2.5% by mass.
[15] A method for producing a starch-containing food having an improved loosening property, comprising the step of:
   obtaining the starch-containing food by the method for improving a loosening property of a starch-containing food according to any one of the above to [14].

The present invention can improve the loosening property of a starch-containing food.

### DESCRIPTION OF EMBODIMENTS

Hereinafter, the present invention will be described in detail by means of examples. Note that in the embodiments of the present invention, the expression A (numerical value) to B (numerical value) means A or more and B or less. In addition, preferable aspects, more preferable aspects, and the like illustrated below can be favorably used in combination as appropriate irrespective of the expressions of “preferable”, “more preferable”, and the like. In addition, the description of numerical ranges are only examples, and it is possible to favorably use ranges in which the upper limits and lower limits of each range as well as numerical values of Examples are combined. Moreover, terms of “comprise”, “contain”, and the like may be read as “consisting essentially of” or “consisting only of”.

### [Loosening Agent for Starch-Containing Food]

The loosening agent for a starch-containing food of the present invention is used in the state of an emulsion product as it is, or the loosening agent for a starch-containing food is emulsified to be used as an emulsion product. In the case of emulsifying the loosening agent for a starch-containing food for use, the loosening agent for a starch-containing food is mixed with water to be an emulsion product. Note that the emulsion product is not particularly limited, but may be an oil-in-water (O/W) emulsion product, a water-in-oil (W/O) emulsion product, a W/O/W emulsion product, or the like, and preferably is an oil-in-water emulsion product.

The loosening agent for a starch-containing food of the present invention comprises: an oil and/or fat composition containing an oil and/or fat and an emulsifier; and a thickening polysaccharide. Since the loosening agent for a starch-containing food of the present invention comprises a thickening polysaccharide, the viscosity of the emulsion product becomes higher than those which do not contain a thickening polysaccharide. Having a higher viscosity of an emulsion product, the loosening agent for a starch-containing food of the present invention has an advantageous effect of improving the loosening property of the starch-containing food. However, a too high viscosity leads to poor workability and coatability to starch-containing foods. For this reason, it is appropriate that the loosening agent for a starch-containing food of the present invention is an emulsion product having a viscosity of 50 to 10000 mPa·s (25° C.), or it is appropriate that the viscosity of the emulsion product obtained by adding water to the loosening agent for a starch-containing food is 50 to 10000 mPa·s (25° C.). Note that the loosening agent for a starch-containing food before adding water may be in a state of substantially not containing water (having no water phase) or an emulsified state containing water. Adding water means emulsification and/or dilution with water. For this reason, the loosening agent for a starch-containing food which substantially does not contain water is turned into an emulsion product by adding water. The loosening agent for a starch-containing food in the emulsified state is diluted by adding water, so that the viscosity of the emulsion product decreases. In addition, it is preferable that the loosening agent for a starch-containing food be an emulsion product having a viscosity of 100 to 9000 mPa·s (25° C.), or that the emulsion product obtained by adding water to the loosening agent for a starch-containing food have a viscosity of 100 to 9000 mPa·s (25° C.). It is more preferable that the loosening agent for a starch-containing food be an emulsion product having a viscosity of 250 to 1000 mPa·s (25° C.), or that the emulsion product obtained by adding water to the loosening agent for a starch-containing food have a viscosity of 250 to 1000 mPa·s (25° C.). It is further preferable that the loosening agent for a starch-containing food be an emulsion product having a viscosity of 400 to 1000 mPa·s (25° C.), or that the emulsion product obtained by adding water to the loosening agent for a starch-containing food have a viscosity of 400 to 1000 mPa·s (25° C.).

Note that in the present invention, the viscosity can be measured in compliance with the Standard Methods for the Analysis of Fats, Oils and Related Materials (2.2.10.5-2013 viscosity (Brookfield method)) specified by Japan Oil Chemists' Society. For example, by using a BM-type viscometer, the viscosity one minute after the start of rotation may be used.

<Oil and/or Fat>

The loosening agent for a starch-containing food of the present invention comprises an oil and/or fat composition, and comprises an oil and/or fat in the oil and/or fat composition. As the oil and/or fat, an animal or vegetable oil and/or fat, an oil and/or fat synthesized from glycerol and a fatty acid, fractionated oil and/or fat of these, an interesterified oil, a hydrogenated oil, or the like may be used alone or in combination.

The animal or vegetable oil and/or fat includes, for example, soybean oil, rapeseed oil, high oleic rapeseed oil, sunflower oil, high oleic sunflower oil, olive oil, safflower oil, high oleic safflower oil, corn oil, cottonseed oil, rice oil, sesame oil, perilla oil, flaxseed oil, peanut oil, grapeseed oil, beef fat, milk fat, fish oil, coconut oil, palm oil, palm kernel oil, and the like.

The oil and/or fat synthesized from glycerol and a fatty acid includes an oil and/or fat containing a linear saturated fatty acid having 6 to 12 carbon atoms, preferably 8 to 10 carbon atoms, for example, a medium-chain fatty acid triglyceride (MCT) having 8 to 10 carbon atoms, and the like.

The fractionated oil includes fractionated oils of palm oil, such as palm olein, palm super olein, palm stearin, and palm mid-fraction.

As the interesterified oil, an interesterified oil of palm oil or a fractionated oil of palm oil with another liquid oil and/or fat, or an interesterified oil of MCT and a vegetable oil or the like can be used.

The hydrogenated oil includes hydrogenated oils of interesterified oils and the like, besides hydrogenated oils of animal or vegetable oils and fractionated oils of animal or vegetable oils.

Regarding the oil and/or fat used in the present invention, since an oil and/or fat that loses fluidity at room temperature (25° C.±5° C.) needs to be dissolved by heating when applied to a starch-containing food, an oil and/or fat that has fluidity at 30° C. is preferable. Even when part of the raw material oil and/or fat is solid at 30° C., the raw material oil and/or fat can be favorably used as long as the oil and/or fat has fluidity as a whole by using another raw material oil and/or fat in combination. An oil and/or fat that has fluidity at 20° C. is more preferable, and an oil and/or fat that is liquid at 20° C. is further preferable. Particularly, an oil and/or fat containing a linear saturated fatty acid having 6 to 12 carbon atoms, and preferably 8 to 10 carbon atoms in a constituent fatty acid of the oil and/or fat, rapeseed oil, palm olein, olive oil, and mixtures of these, and the like can be favorably used since they have advantages that they are liquid oils and/or fats having low melting points but also have favorable oxidative stability. Particularly, an oil and/or fat in which 30% by mass or more of a constituent fatty acid of the oil and/or fat is a linear saturated fatty acid having 8 to 10 carbon atoms is preferable because it provides a favorable loosening property of a starch-containing food. An oil and/or fat in which 50 to 100% by mass of the constituent fatty acid of the oil and/or fat is a linear saturated fatty acid having 8 to 10 carbon atoms is more preferable, and an oil and/or fat in which 80 to 100% by mass of the constituent fatty acid of the oil and/or fat is a linear saturated fatty acid having 8 to 10 carbon atoms is further preferable. The linear saturated fatty acid having 8 to 10 carbon atoms includes caprylic acid and capric acid.

The loosening agent for a starch-containing food of the present invention preferably contains 20 to 99.5% by mass of the oil and/or fat in the oil and/or fat composition (100% by mass). The loosening agent for a starch-containing food of the present invention is used as an emulsion product or is to be used by adding water to the loosening agent for a starch-containing food, and in the case where the loosening agent contains 20 to 99.5% by mass of the oil and/or fat in the oil and/or fat composition, the loosening agent can be sufficiently emulsified with the later-described amount of an emulsifier. In addition, when the loosening agent contains the oil and/or fat within this range, the loosening property of the starch-containing food falls under an acceptable range as used together with an emulsifier and a thickening polysaccharide, which are described later. The amount of the oil and/or fat in the oil and/or fat composition is preferably 20 to 99% by mass, more preferably 20 to 80% by mass, further preferably 30 to 70% by mass, still further preferably 40 to 60% by mass, and most preferably 45 to 55% by mass.

### <Emulsifier>

The loosening agent for a starch-containing food of the present invention contains an emulsifier in the oil and/or fat composition. As the emulsifier, one or two or more selected from glycerol mono-fatty acid esters, polyglycerol fatty acid esters, polyglycerol polyricinoleates, organic acid monoglycerides, sorbitan fatty acid esters, sucrose fatty acid esters, polysorbates, propylene glycol fatty acid esters, and lecithins can be used.

To improve the loosening property, the HLB of the emulsifier is preferably 2 to 10. In the present invention, a plurality of emulsifiers may be contained, and this HLB is the HLB of the whole emulsifiers contained. In addition, an emulsifier having an HLB of 2 to 10 has an emulsifying function, and an emulsion product can be obtained by using the emulsifier in the present invention. Particularly, for efficient emulsification, the HLB of the emulsifier is preferably 3 to 10, more preferably 6 to 10, and further preferably 6 to 8.

HLB is an abbreviation of hydrophile lipophile balance, and serves as an index to find whether the emulsifier is hydrophilic or lipophilic, and takes a value of 0 to 20. A smaller HLB value indicates a higher lipophilicity. In the present invention, for the calculation of the HLB value, the calculation method of the Atlas method is used. The calculation method of the Atlas method refers to a method for calculating an HLB value from

HLB=20×(1−S/A)
S: saponification value,
A: neutralization value of fatty acids in the ester.

In this calculation method, the HLB value is calculated as an arithmetic mean. For example, in the case where an emulsifier having an HLB of 2 and an emulsifier having an HLB of 4 are contained in 1:1 (mass ratio), the HLB of the whole emulsifiers is 3.

In the present invention, the loosening agent for a starch-containing food preferably contains 0.5 to 80% by mass of an emulsifier in the oil and/or fat composition (100% by mass). This range allows sufficient emulsification together with the aforementioned oil and/or fat. The content of the emulsifier is preferably 1 to 80% by mass or 10 to 80% by mass, more preferably 10 to 60% by mass, further preferably 20 to 55% by mass, and still further preferably 30 to 50% by mass, in the oil and/or fat composition, and most preferably 35 to 45% by mass in the oil and/or fat composition.

It is preferable that 60% by mass or more of a constituent fatty acid of the emulsifier contained in the oil and/or fat composition be an unsaturated fatty acid in order to prevent solidification at a low temperature. It is more preferable that 70 to 100% by mass of the constituent fatty acid of the emulsifier be an unsaturated fatty acid, and it is further preferable that 80 to 98% by mass of the constituent fatty acid of the emulsifier be an unsaturated fatty acid. In addition, as the unsaturated fatty acids, for example, a linear unsaturated fatty acid having 16 to 22 carbon atoms, preferably 18 to 22 carbon atoms, and more preferably 18 to 20 carbon atoms can be used. As the unsaturated fatty acid, one or two or more unsaturated fatty acids selected from oleic acid, linoleic acid, linolenic acid, and erucic acid are preferable. Particularly preferably, it is preferable that to 90% by mass of the constituent fatty acid be oleic acid. Fatty acids other than the unsaturated fatty acid in the emulsifier are saturated fatty acids. The saturated fatty acid is preferably a linear saturated fatty acid having 6 to 22 carbon atoms, more preferably a linear saturated fatty acid having 16 to 22 carbon atoms, further preferably a linear saturated fatty acid having 18 to 20 carbon atoms, and it is further preferable to use one or two or more selected from palmitic acid, stearic acid, and behenic acid.

The emulsifier to be used is preferably a diglycerol mono-fatty acid ester and/or a triglycerol mono-fatty acid ester. These emulsifiers have not only a loosening property but also high functions of emulsifying oils and/or fats. For this reason, these emulsifiers can be used alone or together with another emulsifier. For example, as the diglycerol mono-fatty acid ester, a diglycerol fatty acid ester produced by esterifying diglycerol and a fatty acid can be used. As the diglycerol mono-fatty acid ester and/or triglycerol mono-fatty acid ester, those obtained by distilling reaction products to enhance the purity of monoesters are preferably used, but those containing a diester or a triester as impurities may also be used.

In the present invention, the loosening agent for a starch-containing food preferably contains 10 to 60% by mass of a diglycerol mono-fatty acid ester and/or a triglycerol mono-fatty acid ester in the oil and/or fat composition. When the amount of the diglycerol mono-fatty acid ester and/or triglycerol mono-fatty acid ester to be blended is 10% by mass or more, sufficient emulsification can be achieved. In addition, when the amount to be blended is kept to be 60% by mass or less, this allows another emulsifier to be blended, so that synergistic action with another emulsifier can be expected. The content of the diglycerol mono-fatty acid ester and/or triglycerol mono-fatty acid ester is more preferably 20 to 55% by mass in the oil and/or fat composition, further preferably 30 to 50% by mass in the oil and/or fat composition, and still further preferably 35 to 45% by mass in the oil and/or fat composition. A particularly preferable diglycerol mono-fatty acid ester is a diglycerol monooleate.

In the present invention, for the loosening agent for a starch-containing food, one or two or more emulsifiers selected from polyglycerol fatty acid esters in which an average degree of polymerization of polyglycerol is 4 or more, organic acid monoglycerides, propylene glycol fatty acid esters, and lecithins are preferably used. Although these emulsifiers may be also used alone, but using these emulsifiers together with the aforementioned diglycerol mono-fatty acid ester and/or triglycerol mono-fatty acid ester provides an advantageous effect of further improving the loosening property. The content of the one or two or more emulsifiers selected from polyglycerol fatty acid esters in which the average degree of polymerization of polyglycerol is 4 or more, organic acid monoglycerides, propylene glycol fatty acid esters, and lecithins in the oil and/or fat composition is preferably 0 to 40% by mass or more than 0% by mass and 40% by mass or less, more preferably 5 to 30% by mass, further preferably 5 to 20% by mass, and still further preferably 5 to 15% by mass.

A polyglycerol fatty acid ester in which the average degree of polymerization of polyglycerol is 4 or more is synthesized by esterifying polyglycerol and a fatty acid. Polyglycerols to be used as the raw materials of polyglycerol fatty acid esters are generally obtained by conducting dehydration condensation on glycerol as a raw material at a high temperature in the presence of an alkali catalyst such as caustic soda, followed by distillation, deodorization, and decoloration as necessary. These polyglycerols as raw materials of polyglycerol fatty acid esters are also called reactive polyglycerols, and are mixtures of polyglycerols having different degrees of polymerization, and have a wide distribution of the degrees of polymerization. Since polyglycerol fatty acid esters having degrees of polymerization of 4 or more are difficult to isolate in general, mixtures of polyglycerol fatty acid esters having various degrees of polymerization are accepted.

In the present invention, the average degree of polymerization (percentage) indicates the degree of polymerization of the polyglycerol forming the polyglycerol fatty acid ester. Note that the average degree of polymerization mentioned herein is a value calculated from the hydroxyl value of polyglycerol which is the raw material of the polyglycerol fatty acid ester, and, for example, the average degree of polymerization (n) can be calculated from the following formulae (Formula 1) and (Formula 2).

Molecular weight=74×n+18 (Formula 1)

Hydroxyl value=56110×(n+2)/molecular weight (Formula 2)

Then, polyglycerols in general are commercially available as tetraglycerol (average degree of polymerization of 4), hexaglycerol (average degree of polymerization of 6), decaglycerol (average degree of polymerization of 10), and the like called depending on the average degrees of polymerization determined by the end group analysis method, which is obtained by measuring hydroxyl values. Hence, the average degree of polymerization is a value obtained by calculation, and in some cases indicates a value different from the actual degree of polymerization.

The average degree of polymerization of the polyglycerol part of the polyglycerol fatty acid ester is more preferably 4 to 12, further preferably 4 to 10, and still further preferably 4 to 7. Pentaglycerol trioleate, decaglycerol pentaoleate, and polyglycerol polyricinolates are particularly preferable.

The organic acid forming the organic acid monoglyceride is not particularly limited, but citric acid, succinic acid, acetic acid, tartaric acid, butyric acid, and the like can be favorably used. Particularly, citric acid is preferable because an advantageous effect of a high loosening property is exhibited. Glyceryl monooleate citrate and monooleate succinate are particularly preferable.

The propylene glycol fatty acid ester is obtained by esterifying propylene glycol and a fatty acid, and a propylene glycol fatty acid ester having an HLB of 2 to 10 or 3 to 10 can be favorably used.

As the lecithin, egg yolk lecithin or lecithin derived from a plant can be used, and lecithin derived from a plant is preferably used. As raw materials for lecithin derived from a plant, crude oils obtained by compressing and/or extracting oilseeds such as soybean, rapeseed, corn, sunflower, safflower, sesame, and linseed, oil cakes obtained as precipitates by blowing water or water vapor to the crude oils, crude lecithin obtained by drying the separated oil cake, lecithin obtained by removing neutral oil and/or fat component from the crude lecithin by using a publicly-known method such as solvent fractionation, condensed or high-purity lecithin obtained by condensing and fractionating specific phospholipids from the mixture lecithin, and the like can be used. Note that in the present invention, lecithin obtained by desugaring such a raw material is preferable from the viewpoint of suppressing coloration.

Note that in the present invention, as lecithin in the emulsifier, an aceton-insoluble material measured in accordance with “Standard Methods for the Analysis of Fats, Oils and Related Materials 4.3.1-2013 Aceton-insoluble Material” specified by Japan Oil Chemists' Society may be used as the lecithin; however, since this measuring method is not suitable for those containing 5% by mass or less of aceton-insoluble materials, the phosphorus content may be measured and converted to a lecithin content. For example, a loosening agent for a starch-containing food containing phosphorus may be subjected to an optical emission spectroscopy using high-frequency inductively coupled plasma (ICP) as the light source (ICP-optical emission spectroscopy apparatus) to quantify the phosphorus content, and since the ratio between the atomic weight of phosphorus and the molecular weight of lecithin is approximately 1:25, the lecithin content may be obtained by multiplying the phosphorus content by 25.

### <Thickening Polysaccharide>

The loosening agent for a starch-containing food of the present invention contains a thickening polysaccharide. The thickening polysaccharide is a water-soluble polymer substance which has characteristics of improving the viscosity or being gelatinized when dissolved into water, and includes, for example, xanthan gum, galactomannans, tamarind seed gum, carrageenan, agar, pectin, gum arabic, pullulan, soybean polysaccharides, and the like, and one or two or more of these thickening polysaccharides can be used. The thickening polysaccharide is preferably one or two or more selected from xanthan gum and galactomannans. As galactomannans, guar gum and locust bean gum are preferable.

In the present invention, although the loosening agent for a starch-containing food is for use as an emulsion product or is for use as an emulsion product by adding water to the loosening agent for a starch-containing food, the loosening agent for a starch-containing food has an advantageous effect of improving the loosening property of a starch-containing food when the viscosity of the emulsion product is high. For this reason, in the present invention, it is appropriate to blend a thickening polysaccharide. The mass ratio between the oil and/or fat composition and the thickening polysaccharide in the loosening agent for a starch-containing food is preferably oil and/or fat composition:thickening polysaccharide=300:1 to 3:1. The content of the thickening polysaccharide in the emulsion product is preferably 0.01 to 2.5% by mass. When the mass ratio between the oil and/or fat composition and the thickening polysaccharide and/or the content of the thickening polysaccharide are within these ranges, an increase in viscosity of the emulsion product to a certain level is expected, so that the loosening property of the starch-containing food is improved. The mass ratio between the oil and/or fat composition and the thickening polysaccharide in the loosening agent for a starch-containing food is preferably oil and/or fat composition:thickening polysaccharide=200:1 to 3:1, and more preferably oil and/or fat composition:thickening polysaccharide=160:1 to 3:1. The content of the thickening polysaccharide in the emulsion product (100% by mass) is more preferably 0.05 to 2.0% by mass, and the content of the thickening polysaccharide in the emulsion product is further preferably 0.1 to 1.0% by mass.

### <Other Components>

The loosening agent for a starch-containing food of the present invention may contain water. The content of water in the loosening agent for a starch-containing food (100% by mass) is preferably 0 to 99.8% by mass, or more than 0% by mass and 99.8% by mass or less. In the case where the loosening agent for a starch-containing food is an emulsion product, the content of water is preferably 50 to 99.8% by mass, and more preferably 85 to 99.5% by mass.

For the loosening agent for a starch-containing food of the present invention, raw ingredients generally blended with a loosening agent for a starch-containing food can be used besides the above-described components. Specifically, for example, ethanol, pH adjusters, seasoning agents, coloring agents, flavors, antioxidants, sugars, sugar alcohols, stabilizers, emulsifiers, and the like can be used. The amount of these components may be any desired amount as long as the advantageous effects of the present invention is not impaired. For example, these components may be contained in an amount of 10% by mass or less, preferably 0 to 3% by mass or more than 0% by mass and 3% by mass or less, and more preferably 0 to 1% by mass or more than 0% by mass and 1% by mass or less, in the loosening agent for a starch-containing food (100% by mass).

### [Emulsion Product of Loosening Agent for Starch-Containing Food]

The loosening agent for a starch-containing food is used for application as an actual loosening agent, as the loosening agent for a starch-containing food itself in the state of an emulsion product, or an emulsion product obtained by adding water to the loosening agent for a starch-containing food for emulsification. In this meaning, a loosening agent for a starch-containing food which is not emulsified or has a viscosity outside the above-described range of 50 to 10000 mPa·s (25° C.) can be said to be an intermediate of the loosening agent for a starch-containing food in the form of emulsion product. By making the loosening agent for a starch-containing food into an emulsion product having a specific high viscosity by the action of a thickening polysaccharide and the like, an advantageous effect of improving the loosening property of a starch-containing food is exhibited. Here, if the viscosity is too high, the workability or coatability to the starch-containing food becomes poor. Hence, the viscosity of the emulsion product of the loosening agent for a starch-containing food of the present invention can be adjusted by adjusting the content of water contained in the emulsion product. It is appropriate that the loosening agent for a starch-containing food in the form of emulsion product has, for example, a viscosity of 50 to 10000 mPa·s (25° C.), more preferably a viscosity of 250 to 1000 mPa·s (25° C.), further preferably 400 to 1000 mPa·s (25° C.), and particularly preferably a viscosity of 400 to 1000 mPa·s (25° C.). Besides, the definition and a preferable aspect of the emulsion product is as described above.

### [Starch-Containing Food]

The loosening agent for a starch-containing food of the present invention is used for starch-containing foods. The starch-containing foods include processed foods made by kneading raw materials mainly composed of grain powders such as wheat flour, buckwheat flour, rice flour, dogtooth violet starch, arrowroot flour, foxtail millet flour, konjac flour, and tapioca flour with water. The starch-containing foods include, for example, noodles such as soba noodles, udon noodles, thin wheat noodles, cold wheat noodles, Chinese noodles, rice flour noodles, cold noodles, and pastas (long pastas), paste products such as suiton, macaroni, short pasta, dumpling skin, and spring roll skin other than noodles, and rice foods such as rice, fried rice, curry rice, and rice bowl. The loosening agent for a starch-containing food is applied in the form of emulsion product having a viscosity of 50 to 10000 mPa·s (25° C.) to these starch-containing foods, and can be used to coat starch-containing foods with the loosening agent for a starch-containing food, thus providing starch-containing foods having an improved loosening property. As the amount of the loosening agent for a starch-containing food to be applied, the loosening agent for a starch-containing food in the form of emulsion product is preferably applied in an amount of 0.1 to 7 parts by mass, and more preferably applied in an amount of 0.2 to 5.0 parts by mass, relative to 100 parts by mass of the starch-containing food. In the case where the loosening agent for a starch-containing food of the present invention is applied to a starch-containing food, the loosening agent for a starch-containing food in the emulsified form may be applied to the starch-containing food immediately after the starch-containing food is boiled in hot water of around 90 to 100° C., or after the boiled starch-containing food is cooled down to room temperature (25° C.±5° C.).

### [Method for Improving Loosening Property of Starch-Containing Food]

The method for improving a loosening property of a starch-containing food of the present invention is that the aforementioned loosening agent for a starch-containing food is used and applied to a starch-containing food. That is, the method for improving a loosening property of a starch-containing food comprises the steps of emulsifying an oil and/or fat composition containing an oil and/or fat and an emulsifier together with a thickening polysaccharide, and optionally water, to obtain an emulsion product having a viscosity of 50 to 10000 mPa·s (25° C.) and applying the emulsion product to a starch-containing food. Note that in the method for improving a loosening property of a starch-containing food of the present invention, an emulsion product having a viscosity which is lowered to 50 to 10000 mPa·s (25° C.) by adding water with mixing after the emulsion product having a viscosity of more than 50 mPa·s (25° C.) is obtained by emulsification may be applied to a starch-containing food.

The detail of the loosening agent for a starch-containing food to be used in the method for improving a loosening property of a starch-containing food of the present invention and the starch-containing food thus obtained are as described above. The method for applying the loosening agent for a starch-containing food to a starch-containing food is not particularly limited, but includes methods of immersing, spraying, dressing, and the like. As the loosening property is improved in this way, the problem of sticking of the starch-containing food during distribution or storage can be improved, so that a starch-containing food having an improved loosening property which does not stick and can be easily separated can be provided without requiring the step of immersing the starch-containing food into water to detangling the starch-containing food during eating, or the like.

### [Method for Producing Starch-Containing Food Having Improved Loosening Property]

The method for producing a starch-containing food having an improved loosening property of the present invention comprises the step of: obtaining the starch-containing food by the aforementioned method for improving a loosening property of a starch-containing food. Specifically, the method for producing a starch-containing food having an improved loosening property comprises the steps of emulsifying an oil and/or fat composition containing an oil and/or fat and an emulsifier together with a thickening polysaccharide to obtain an emulsion product having a viscosity of 50 to 10000 mPa·s (25° C.); and applying the emulsion product to preferably a surface of a starch-containing food to obtain a starch-containing food having an improved loosening property. The definition in detail and a preferable aspect of each term is as described above.

### EXAMPLES

Next, the present invention will be described in further detail by presenting Examples, Comparative Examples, and Reference Example; however, the present invention is not limited to these. In addition, in the following, “%” indicates % by mass unless otherwise stated.

[Oil and/or Fat Compositions]

Oil and/or fat compositions 1 to 11 were each obtained by mixing an oil and/or fat and an emulsifier in the blending ratio in Tables 1 to 3. In addition, raw ingredients used are as follows.
MCT (medium-chain fatty acid triglyceride in which constituent fatty acids are caprylic acid and capric acid: produced by The Nisshin OilliO Group, Ltd.)
Rapeseed oil (refined canola oil, trade name “Nisshin Canola Oil”: produced by The Nisshin OilliO Group, Ltd.)
Diglycerol monooleate (produced by Riken Vitamin Co., Ltd., trade name “POEM DO-100V”: HLB 7.3)
Glyceryl monooleate citrate (produced by Taiyo Kagaku Co. Ltd., trade name “SUNSOFT No. 623M”: HLB 7)
Pentaglycerol trioleate (produced by Taiyo Kagaku Co. Ltd., trade name “SUNSOFT A-173E”: HLB 7)
Crude lecithin (produced by The Nisshin OilliO Group, Ltd., phospholipid content 65% by mass)
Propylene glycol oleate (produced by Riken Vitamin Co., Ltd., trade name “RIKEMAL PO-100V”: HLB 3.6)
Decaglycerol pentaoleate (produced by Taiyo Kagaku Co. Ltd., trade name “SUNSOFT Q-175S”: HLB 7)
Polyglycerol polyricinolates (produced by Taiyo Kagaku Co. Ltd., trade name “SUNSOFT No. 818H”: HLB about 2)
Glycerol monooleate succinate (produced by Taiyo Kagaku Co. Ltd., trade name “SUNSOFT 683CB”): HLB 8.5)

TABLE 1

| | | Oil and/or fat | | |
|---|---|---|---|---|
| | | composition | | |
| | | 1 | 2 | 3 |
| Oil and/or | MCT [% by mass] | 50 | 50 | 50 |
| fat | Rapeseed oil [% by mass] | | | |
| Emulsifier | Diglycerol monooleate [% by mass] | 40 | 40 | 40 |
| | Glyceryl monooleate citrate [% by mass] | | | 10 |
| | Pentaglycerol trioleate [% by mass] | | | |
| | Crude lecithin [% by mass] | | | |
| | Propylene glycol oleate [% by mass] | | 10 | |

TABLE 2

| | | Oil and/or fat | | | |
|---|---|---|---|---|---|
| | | composition | | | |
| | | 4 | 5 | 6 | 7 |
| Oil and/or | MCT [% by mass] | 50 | 20 | | 50 |
| fat | Rapeseed oil [% by mass] | | 30 | 50 | |
| Emulsifier | Diglycerol monooleate [% by mass] | 45 | 40 | 40 | 40 |
| | Glyceryl monooleate citrate [% by mass] | | 10 | 10 | |
| | Pentaglycerol trioleate [% by mass] | 5 | | | |
| | Crude lecithin [% by mass] | | | | 10 |
| | Propylene glycol oleate [% by mass] | | | | |

TABLE 3

| | | Oil and/or fat | | | |
|---|---|---|---|---|---|
| | | composition | | | |
| | | 8 | 9 | 10 | 11 |
| Oil and/or | Rapeseed oil [% by mass] | 98 | 98 | 98 | |
| fat | Olive oil [% by mass] | | | | |
| Emulsifier | Diglycerol monooleate [% by mass] | | | | |
| | Decaglycerol pentaoleate [% by mass] | 2 | 1 | | 1 |
| | Polyglycerol polyricinolates [% by mass] | | 1 | 1 | |
| | Monooleate succinate [% by mass] | | | 1 | |

### [Loosening Agents (Loosening Agents for a Starch-Containing Food) 1 to 29]

Loosening agents were prepared in the blends of Tables 4 to 11. Note that as Loosening agents 2 and 3, emulsion products were obtained by mixing an oil and/or fat composition and water. As Loosening agent 4, a thickening polysaccharide (xanthan gum) was added to and mixed with water. As Loosening agents 5 to 29, emulsion products (oil-in-water emulsion products) were obtained by adding a thickening polysaccharide (xanthan gum or guar gum) to an oil and/or fat composition and further adding and mixing water. The thickening polysaccharides used are as follows.
Xanthan gum (produced by Taiyo Kagaku Co. Ltd., trade name “NEOSOFT XR”)
Guar gum (produced by UNITECH FOODS Co., Ltd., trade name “VIDOGUM GHK175”)

### [Viscosity]

The viscosity at 25° C. of each Loosening agent one minute after the start of rotation was measured by using a Brookfield viscometer (BM-type viscometer, manufactured by TOKI SANGYO CO. Ltd., trade name “VISCOMETER TVB-15”).

### [Loosening Property of Noodle]

A commercially-available udon noodle (produced by TableMark Co., Ltd., trade name “TOPVALU BESTPRICE SANUKI UDON”) was boiled for one minute in hot water of 100° C. The boiled noodle was cut into a length of 3 to 4 cm. The loosening agent was added to the cut noodle, and mixed to attach 3 g of the loosening agent to 100 g of the cut noodle (3 parts by mass to 100 parts by mass of the noodle). The noodle to which the loosening agent was added was packed in a container having an opening portion of 10 cm×10 cm and a depth of 2.6 cm, and was stored for 24 hours at 10° C.

After the storage, the container was set at a height of 1 m from the flat surface of stainless steel, and the noodle was dropped from the container toward the surface of stainless steel, and the maximum distance (maximum diameter) of the noodle spread on the surface of stainless steel was measured, and a value was obtained as the loosening property of the noodle by subtracting the maximum distance of the noodle of Reference Example 1 from the maximum distance of the noodle of each sample.

The loosening property of the noodle (cm)=(the maximum distance of the noodle of the sample)−(the maximum distance of the noodle of Reference Example 1)

A larger numerical value indicates that the noodle was spread wider and had a better loosening property.

TABLE 4

| | Ref- | Com- | Com- | Com- |
|---|---|---|---|---|
| | erence | parative | parative | parative |
| | Exam- | Exam- | Exam- | Exam- |
| | ple 1 | ple 1 | ple 2 | ple 3 |
| Blend of Loosening | Loosening | Loosening | Loosening | Loosening |
| agent | agent 1 | agent 2 | agent 3 | agent 4 |
| Oil and/or fat | | 6.7 | | |
| composition 3 | | | | |
| [% by mass] | | | | |
| Oil and/or fat | | | 6.7 | |
| composition 4 | | | | |
| [% by mass] | | | | |
| Xanthan gum | | | | 0.3 |
| [% by mass] | | | | |
| Water [% by mass] | 100 | 93.3 | 93.3 | 99.7 |
| Viscosity [mPa · s] | 2.1 | 26.7 | 25.4 | 250 |
| (Rotor No., rpm) | (M1, 60) | (M1, 30) | (M1, 30) | (M2, 30) |
| Loosening property | 0.0 | 1.8 | 1.5 | 0.1 |
| of noodle (cm) | | | | |

TABLE 5

| | Example 1 | Example 2 |
|---|---|---|
| Blend of Loosening agent | Loosening | Loosening |
| | agent 5 | agent 6 |
| Oil and/or fat composition 1 [% by mass] | 6.7 | |
| Oil and/or fat composition 2 [% by mass] | | 6.7 |
| Xanthan gum [% by mass] | 0.3 | 0.3 |
| Water [% by mass] | 93.0 | 93.0 |
| Viscosity [mPa · s] | 1008 | 975 |
| (Rotor No., rpm) | (M2, 12) | (M2, 12) |
| Loosening property of noodle (cm) | 5.3 | 6.1 |

TABLE 6

| | Example 3 | Example 4 | Example 5 | Example 6 |
|---|---|---|---|---|
| Blend of Loosening agent | Loosening | Loosening | Loosening | Loosening |
| | agent 7 | agent 8 | agent 9 | agent 10 |
| Oil and/or fat | 6.70 | 6.7 | 6.7 | 6.7 |
| composition 3 | | | | |
| [% by mass] | | | | |
| Xanthan gum [% by mass] | 0.05 | 0.1 | 0.2 | 0.5 |
| Water [% by mass] | 93.25 | 93.2 | 93.1 | 92.8 |
| Viscosity [mPa · s] | 104 | 280 | 560 | 1561 |
| (Rotor No., rpm) | (M2, 12) | (M2, 12) | (M2, 12) | (M2, 12) |
| Loosening property of | 5.3 | 7.9 | 10.0 | 5.5 |
| noodle (cm) | | | | |

TABLE 7

| | Example 7 | Example 8 |
|---|---|---|
| Blend of Loosening agent | Loosening agent | Loosening agent |
| | 11 | 12 |
| Oil and/or fat composition 3 | 6.7 | 6.7 |
| [% by mass] | | |
| Xanthan gum [% by mass] | 1.0 | 2.0 |
| Water [% by mass] | 93.25 | 93.2 |
| Viscosity [mPa · s] | 3450 | 8500 |
| (Rotor No., rpm) | (M3, 12) | (M4, 12) |
| Loosening property of noodle (cm) | 5.2 | 4.1 |

TABLE 8

| | Example 9 | Example 10 | Example 11 | Example 12 |
|---|---|---|---|---|
| Blend of Loosening | Loosening | Loosening | Loosening | Loosening |
| agent | agent 14 | agent 15 | agent 16 | agent 17 |
| Oil and/or fat | 0.5 | 1.0 | 2.0 | 3.0 |
| composition 3 | | | | |
| [% by mass] | | | | |
| Xanthan gum | 0.2 | 0.2 | 0.2 | 0.2 |
| [% by mass] | | | | |
| Water [% by mass] | 99.3 | 98.8 | 97.8 | 96.8 |
| Viscosity [mPa · s] | 87 | 88 | 517 | 664 |
| (Rotor No., rpm) | (M2, 12) | (M2, 12) | (M2, 12) | (M2, 12) |
| Loosening property | 3.3 | 3.9 | 6.1 | 3.5 |
| of noodle (cm) | | | | |

TABLE 9

| | Exam- | Exam- | Exam- | Exam- |
|---|---|---|---|---|
| | ple 13 | ple 14 | ple 15 | ple 16 |
| Blend of Loosening | Loosening | Loosening | Loosening | Loosening |
| agent | agent 18 | agent 19 | agent 20 | agent 21 |
| Oil and/or fat | 5.0 | 8.0 | 10.0 | 20.0 |
| composition 3 | | | 0.2 | |
| [% by mass] | | | | |
| Xanthan gum | 0.2 | | 0.2 | 0.2 |
| [% by mass] | | | | |
| Water [% by mass] | 94.8 | 91.8 | 89.8 | 78.8 |
| Viscosity [mPa · s] | 636 | 807 | 902 | 670 |
| (Rotor No., rpm) | (M2, 12) | (M2, 12) | (M2, 12) | (M2, 12) |
| Loosening property | 6.8 | 7.2 | 10.2 | 6.5 |
| of noodle (cm) | | | | |

TABLE 10

| | Exam- | Exam- | Exam- | Exam- |
|---|---|---|---|---|
| | ple 17 | ple 18 | ple 19 | ple 20 |
| Blend of Loosening | Loosening | Loosening | Loosening | Loosening |
| agent | agent 22 | agent 23 | agent 24 | agent 25 |
| Oil and/or fat | 6.7 | | | |
| composition 3 | | | | |
| [% by mass] | | | | |
| Oil and/or fat | | 6.7 | | |
| composition 5 | | | | |
| [% by mass] | | | | |
| Oil and/or fat | | | 6.7 | |
| composition 6 | | | | |
| [% by mass] | | | | |
| Oil and/or fat | | | | 6.7 |
| composition 7 | | | | |
| [% by mass] | | | | |
| Guar gum | 0.3 | 0.3 | 0.3 | 0.2 |
| [% by mass] | | | | |
| Water [% by mass] | 93.0 | 93.0 | 93.0 | 93.1 |
| Viscosity [mPa · s] | 56.2 | 728 | 635 | 612 |
| (Rotor No., rpm) | (M1, 12) | (M1, 12) | (M1, 12) | (M2, 12) |
| Loosening property | 3.1 | 5.5 | 8.5 | 2.9 |
| of noodle (cm) | | | | |

TABLE 11

| | Exam- | Exam- | Exam- | Exam- |
|---|---|---|---|---|
| | ple 21 | ple 22 | ple 23 | ple 24 |
| Blend of Loosening | Loosening | Loosening | Loosening | Loosening |
| agent | agent 26 | agent 27 | agent 28 | agent 29 |
| Oil and/or fat | 7.0 | | | |
| composition 8 | | | | |
| [% by mass] | | | | |
| Oil and/or fat | | 7.0 | | |
| composition 9 | | | | |
| [% by mass] | | | | |
| Oil and/or fat | | | | |
| composition 10 | | | 7.0 | |
| [% by mass] | | | | |
| Oil and/or fat | | | | 7.0 |
| composition 11 | | | | |
| [% by mass] | | | | |
| Xanthan gum | 0.5 | 0.5 | 0.5 | 0.5 |
| [% by mass] | | | | |
| Water [% by mass] | 92.5 | 92.5 | 92.5 | 92.5 |
| Viscosity [mPa · s] | 1575 | 1574 | 1513 | 1572 |
| (Rotor No., rpm) | (M2, 12) | (M2, 12) | (M2, 12) | (M2, 12) |
| Loosening property | 5.9 | 7.8 | 8.5 | 5.3 |
| of noodle (cm) | | | | |

All Examples 1 to 24 had a more favorable loosening property than Reference Example 1, and Comparative Examples 1 to 3.

1. A loosening agent for a starch-containing food, that is for use as an emulsion product or is for use as an emulsion product by adding water to the loosening agent for a starch-containing food, comprising:
an oil and/or fat composition containing an oil and/or fat and an emulsifier; and
a thickening polysaccharide, wherein
the emulsion product has a viscosity of 50 to 10000 mPa·s (25° C.).

2. The loosening agent for a starch-containing food according to claim 1, wherein
a content of the oil and/or fat in the oil and/or fat composition is 20 to 99.5% by mass,
a content of the emulsifier in the oil and/or fat composition is 0.5 to 80% by mass, and
an HLB of the emulsifier is 2 to 10.

3. The loosening agent for a starch-containing food according to claim 1, wherein
the emulsifier is one or two or more selected from glycerol mono-fatty acid esters, polyglycerol fatty acid esters, polyglycerol polyricinoleates, organic acid monoglycerides, sorbitan fatty acid esters, sucrose fatty acid esters, polysorbates, propylene glycol fatty acid esters, and lecithins.

4. The loosening agent for a starch-containing food according to claim 1, wherein
in the oil and/or fat composition,
a content of a diglycerol mono-fatty acid ester and/or a triglycerol mono-fatty acid ester is 10 to 60% by mass, and
a content of one or two or more emulsifiers selected from polyglycerol fatty acid esters in which an average degree of polymerization of polyglycerol is 4 or more, organic acid monoglycerides, propylene glycol fatty acid esters, and lecithins is 0 to 40% by mass.

5. The loosening agent for a starch-containing food according to claim 1, wherein
the thickening polysaccharide is one or two or more selected from xanthan gum and galactomannans.

6. The loosening agent for a starch-containing food according to claim 1, wherein
a mass ratio between the oil and/or fat composition and the thickening polysaccharide in the loosening agent for a starch-containing food is oil and/or fat composition:thickening polysaccharide=300:1 to 3:1, and/or
a content of the thickening polysaccharide in the emulsion product is 0.01 to 2.5% by mass.

7. The loosening agent for a starch-containing food according to claim 1, wherein
30% by mass or more of a constituent fatty acid of the oil and/or fat in the oil and/or fat composition is a linear saturated fatty acid having 8 to 10 carbon atoms, and
60% by mass or more of a constituent fatty acid of the emulsifier in the oil and/or fat composition is an unsaturated fatty acid.

8. The loosening agent for a starch-containing food according to claim 1, further comprising:
more than 0% by mass and 99.8% by mass or less of water.

9. The loosening agent for a starch-containing food according to claim 8, that is in a form of an emulsion product having a viscosity of 50 to 10000 mPa·s (25° C.).

10. A starch-containing food having an improved loosening property, comprising:
a starch-containing food; and
the loosening agent for a starch-containing food according to claim 1, that is applied to a surface of the starch-containing food.

11. A method for improving a loosening property of a starch-containing food, comprising the steps of:
emulsifying an oil and/or fat composition containing an oil and/or fat and an emulsifier together with a thickening polysaccharide to obtain an emulsion product having a viscosity of 50 to 10000 mPa·s (25° C.); and
applying the emulsion product to a starch-containing food.

12. The method for improving a loosening property of a starch-containing food according to claim 11, wherein
a content of the oil and/or fat in the oil and/or fat composition is 20 to 99.5% by mass,
a content of the emulsifier in the oil and/or fat composition is 0.5 to 80% by mass, and
an HLB of the emulsifier is 2 to 10.

13. The method for improving a loosening property of a starch-containing food according to claim 11, wherein
in the oil and/or fat composition,
a content of a diglycerol mono-fatty acid ester and/or a triglycerol mono-fatty acid ester is 10 to 60% by mass, and
a content of one or two or more emulsifiers selected from polyglycerol fatty acid esters in which an average degree of polymerization of polyglycerol is 4 or more, organic acid monoglycerides, propylene glycol fatty acid esters, and lecithins is 0 to 40% by mass.

14. The method for improving a loosening property of a starch-containing food according to claim 11, wherein
the thickening polysaccharide is one or two or more selected from xanthan gum and galactomannans,
a mass ratio between the oil and/or fat composition and the thickening polysaccharide is oil and/or fat composition:thickening polysaccharide=300:1 to 3:1, and/or
a content of the thickening polysaccharide in the emulsion product is 0.01 to 2.5% by mass.

15. A method for producing a starch-containing food having an improved loosening property, comprising the step of:
obtaining the starch-containing food by the method for improving a loosening property of a starch-containing food according to claim 11.

16. The method for producing a starch-containing food having an improved loosening property according to claim 15, wherein
a content of the oil and/or fat in the oil and/or fat composition is 20 to 99.5% by mass,
a content of the emulsifier in the oil and/or fat composition is 0.5 to 80% by mass, and
an HLB of the emulsifier is 2 to 10.

17. The method for producing a starch-containing food having an improved loosening property according to claim 15, wherein
in the oil and/or fat composition,
a content of a diglycerol mono-fatty acid ester and/or a triglycerol mono-fatty acid ester is 10 to 60% by mass, and
a content of one or two or more emulsifiers selected from polyglycerol fatty acid esters in which an average degree of polymerization of polyglycerol is 4 or more, organic acid monoglycerides, propylene glycol fatty acid esters, and lecithins is 0 to 40% by mass.

18. The method for producing a starch-containing food having an improved loosening property according to claim 15, wherein
the thickening polysaccharide is one or two or more selected from xanthan gum and galactomannans,
a mass ratio between the oil and/or fat composition and the thickening polysaccharide is oil and/or fat composition:thickening polysaccharide=300:1 to 3:1, and/or
a content of the thickening polysaccharide in the emulsion product is 0.01 to 2.5% by mass.
